(19) United States
(12) Patent Application Publication
(10) Pub. No.: US 2018/0017668 A1
(43) Pub. Date: Jan. 18, 2018

(54) RANGING SYSTEM, INTEGRATED PANORAMIC REFLECTOR AND PANORAMIC COLLECTOR

(71) Applicant: INSTITUT NATIONAL D'OPTIQUE, Québec (CA)

(72) Inventors: Pierre COTTIN, Québec (CA); Min WANG, Québec (CA); Daniel CANTIN, Québec (CA)

(21) Appl. No.: 15/652,664

(22) Filed: Jul. 18, 2017

Related U.S. Application Data
(60) Provisional application No. 62/363,682, filed on Jul. 18, 2016.

(51) Int. Cl. G01S 7/486; G01S 7/481; G01S 13/10

(52) U.S. Cl. CPC G01S 7/4865; G01S 13/10; G01S 7/4813; G01S 7/4817; G01S 7/4863

(57) ABSTRACT

The ranging system has an axis defining azimuthal coordinates around the axis; a panoramic projector adapted to project an illumination beam towards azimuthally-spaced areas around the axis; a panoramic collector being adapted to receive a return light beam from illuminated areas and to collect the return light beam onto a focal area; an array of time-of-flight (ToF) sensors positioned at the focal area, each ToF sensor of the array being adapted to sense an intensity of the return light beam incoming from the azimuthally-spaced areas; and a computing device configured to operate the panoramic projector and the array of ToF sensors in a synchronized manner allowing to determine, for each ToF sensor of the array, a range value indicative of the range between the panoramic projector and a target positioned in at least one of the azimuthally-spaced areas.

### FIELD

The improvements generally relate to the field of ranging systems and more particularly to the field of panoramic ranging systems.

### BACKGROUND

Ranging systems are generally used to produce an indication of range between an object in a scene and a sensor device. In some ranging systems, the indication of range is determined based on the known speed of light.

Although the existing ranging systems are satisfactory to a certain degree, there remains room for improvement.

### SUMMARY

One specific need occurs in providing a panoramic ranging system which does not rely on the use of movable parts.

In accordance with one aspect, there is provided a ranging system comprising: a housing; an axis fixed relative to the housing and defining azimuthal coordinates around the axis; a panoramic projector mounted to the housing and adapted to project an illumination beam towards azimuthally-spaced areas around the axis; a panoramic collector mounted to the housing, the panoramic collector being adapted to receive a return light beam from illuminated areas and to collect the return light beam onto at least one focal area; at least one array of time-of-flight (ToF) sensors mounted to the housing and positioned at the at least one focal area, each ToF sensor of the at least one array being adapted to sense an intensity of the return light beam incoming from the azimuthally-spaced areas; and a computing device configured to operate the panoramic projector and the at least one array of ToF sensors in a synchronized manner allowing to determine, for each ToF sensor of the at least one array, a range value indicative of the range between the panoramic projector and a target positioned in at least one of the azimuthally-spaced areas.

One specific need occurs in providing a panoramic reflector with reduced alignment requirements and increased vibration resistance.

In accordance with another aspect, there is provided an integrated panoramic reflector comprising: a cylindrical body having a first end and a second end, the body extending along an axis between the first end and the second end, the body being made of an optically transparent material, the first end having a convex shape, the second end having a conical recess, the convex shape and the conical recess being aligned with one another along the axis, the conical recess having a reflective surface, and the convex shape being adapted to collimate incoming light inside the cylindrical body and towards the second end, the reflective surface of the conical recess being adapted to reflect light towards azimuthally-spaced areas around the cylindrical body.

One specific need occurs in providing a panoramic collector and a panoramic sensor assembly with an increase azimuthal resolution.

In accordance with another aspect, there is provided a panoramic collector comprising: a frame; an axis fixed relatively to the frame; four reflective lateral faces arranged in a rectangular pyramidal configuration, each of the four reflective lateral faces being adapted to receive a return light beam from a corresponding one of four azimuthal fields of view around the frame and to collect the received return light beam towards the axis; and a lens assembly mounted to the frame and adapted to receive the reflected return light beam from the four reflective lateral faces and to focus the reflected return light beam towards a focal area across the axis.

In accordance with another aspect, there is provided a ranging system comprising: a housing; an axis fixed relative to the housing and defining azimuthal coordinates around the axis; a panoramic projector mounted to the housing and adapted to project an illumination beam towards azimuthally-spaced areas around the axis; a panoramic collector having a frame being mounted inside the housing, four reflective lateral faces arranged in a rectangular pyramidal configuration, each of the four reflective lateral faces being adapted to receive a return light beam from a corresponding one of four azimuthal fields of view around the frame and to redirect the received return light beam towards the axis; and a lens assembly mounted to the frame and adapted to receive the reflected return light beam from the four reflective lateral faces and to focus the reflected return light beam towards a focal area across the axis; a rectangular array of time-of-flight (ToF) sensors mounted to the housing and positioned at the focal area, each ToF sensor of the array being adapted to sense an intensity of the return light beam incoming from the azimuthally-spaced areas; and a computing device configured to operate the panoramic projector and the array of ToF sensors in a synchronized manner allowing to determine, for each ToF sensor of the array, a range value indicative of the range between the panoramic projector and a target positioned in at least one of the azimuthally-spaced areas.

In accordance with another aspect, there is provided a panoramic sensor assembly comprising: a frame; an axis fixed relatively to the frame; four reflective lateral faces arranged in a rectangular pyramidal configuration, each of the four reflective lateral faces being adapted to receive a return light beam from a corresponding one of four azimuthal fields of view around the frame and to redirect the received return light beam towards the axis; a lens assembly mounted to the frame and adapted to receive the reflected return light beam from the four reflective lateral faces and to focus the reflected return light beam towards a focal area across the axis; and a rectangular array of sensors mounted to the frame and positioned at the focal area in a manner that light received from each one of the four azimuthally-spaced fields of view is distributed along a corresponding side of the rectangular array.

Many further features and combinations thereof concerning the present improvements will appear to those skilled in the art following a reading of the instant disclosure.

### DESCRIPTION OF THE FIGURES

In the figures,

FIG. 1 is a schematic view of an example of a ranging system having a circular field of illumination therearound, in accordance with an embodiment;

FIG. 1A is a top plan view of the ranging system of FIG. 1;

FIG. 1B is a top plan view of an array of ToF sensors of the ranging system of FIG. 1, in accordance with an embodiment;

FIG. 1C is a graph of exemplary range values as a function of azimuthal coordinates for the circular field of view and illumination of the ranging system of FIG. 1;

FIG. 2 is a top plan view of another example of a ranging system having two different fields of illumination therearound, in accordance with an embodiment;

FIG. 2A is a top plan view of an array of ToF sensors of the ranging system of FIG. 2, in accordance with an embodiment;

FIG. 2B is a graph of exemplary range values as a function of azimuthal coordinates for the two different fields of view of the ranging system of FIG. 2;

FIG. 3 is a side elevation view of another example of a ranging system having fields of illumination at two different elevation angles, in accordance with an embodiment;

FIG. 3A is a top plan view of an array of ToF sensors of the ranging system of FIG. 3, in accordance with an embodiment;

FIG. 3B is a graph of exemplary range values as a function of azimuthal coordinates for the two different fields of illumination of the ranging system of FIG. 3;

FIG. 4 is an oblique view of another example of a ranging system having two different fields of illumination, in accordance with an embodiment;

FIG. 4A is a top plan view of an array of ToF sensors of the ranging system of FIG. 4, in accordance with an embodiment;

FIG. 5 is a sectional view of an example of a panoramic projector, in accordance with an embodiment;

FIG. 6 is a sectional view of another example of a panoramic projector including an integrated panoramic reflector, in accordance with an embodiment;

FIG. 6A is an oblique view of the integrated panoramic reflector of FIG. 6;

FIG. 7 is a sectional view of another example of a panoramic projector including a plurality of optical sources, in accordance with an embodiment;

FIG. 8 is a sectional view of an example of a panoramic collector including a focussing lens assembly, in accordance with an embodiment;

FIG. 9 is a sectional view of an example of the focussing lens assembly of the panoramic collector of FIG. 8;

FIG. 10 is a sectional view of another example of a panoramic collector including a panoramic reflector and a focussing lens assembly, in accordance with an embodiment;

FIG. 11 is a sectional view of the panoramic reflector and the focussing lens assembly of the panoramic collector of FIG. 10;

FIG. 12 is a sectional view of an example of a panoramic detector assembly, in accordance with an embodiment;

FIG. 12A is a bottom plan view of a panoramic reflector of the panoramic detector assembly of FIG. 12;

FIG. 12B is top plan view of a rectangular array of ToF sensors of the panoramic detector assembly, in accordance with an embodiment;

FIG. 13 is a sectional view of another example of a ranging system including the panoramic detector assembly of FIG. 12;

FIG. 13A is a schematic view showing a computing device of the ranging system of FIG. 13;

FIG. 13B is a top plan view of an example of a range image as produced by the ranging system of FIG. 13;

FIG. 14 is a sectional view of another example of a ranging system including the integrated panoramic reflector of FIG. 6 and the panoramic detector assembly of FIG. 12, in accordance with an embodiment;

FIG. 15 is a top view of another example of a panoramic projector, having a frame with a projector sub assembly on each face thereof;

FIG. 16 is a top view of another example of a panoramic collector, having a frame with a collector lens assembly on each face thereof;

FIG. 17 is a side view of another example of a ranging system including the panoramic projector of FIG. 15 and the panoramic collector of FIG. 16 in a stacked configuration;

FIG. 18 is a top view of another example of a ranging system including the panoramic projector of FIG. 15 and the panoramic collector of FIG. 16 in a side-by-side configuration; and

FIG. 19 is an oblique view of the ranging system of FIG. 18.

### DETAILED DESCRIPTION

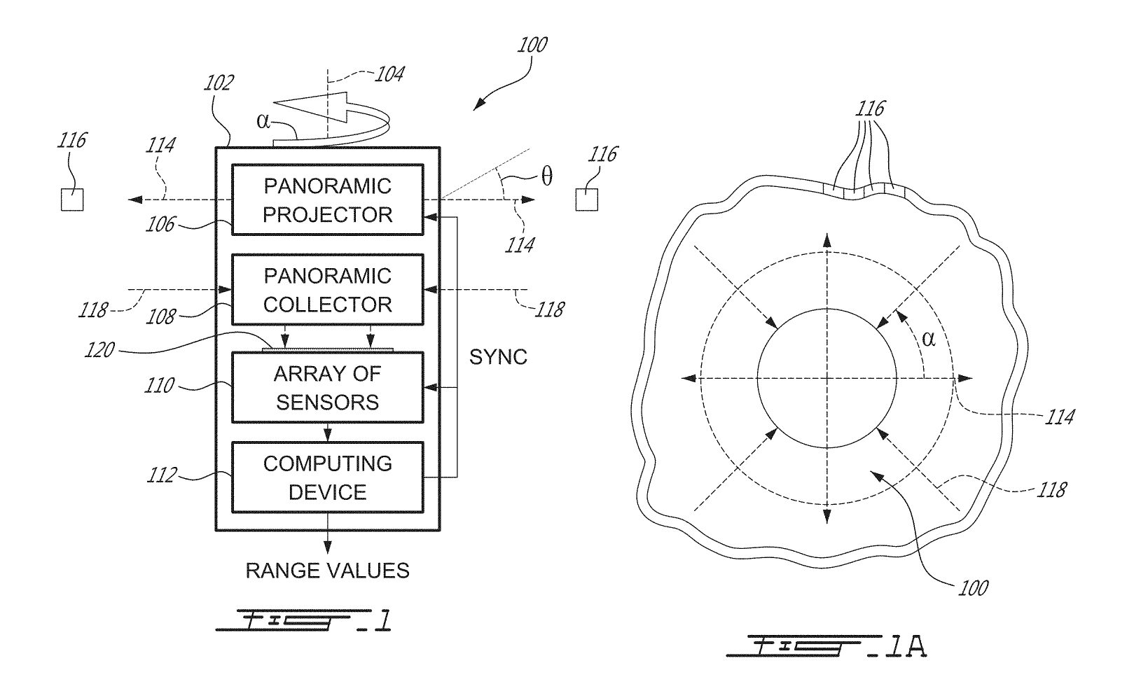

FIG. 1 is a schematic view of an example of a ranging system 100 for sensing the range of objects, referred to herein as targets, distributed therearound.

As depicted, the ranging system 100 has a housing 102, an axis 104 fixed relative to the housing 102, a panoramic projector 106, a panoramic collector 108, an array of sensors 110 and a computing device 112.

As it will be understood, in this disclosure, the axis 104 defines azimuthal coordinate α therearound. More specifically, the azimuthal coordinate is measured in a given plane perpendicular to the axis 104 whereas elevation coordinate e is measured generally perpendicularly from this given plane.

As illustrated, the panoramic projector 106 is adapted to provide an illumination beam 114 towards a set of azimuthally-spaced areas 116 around the axis 104 whereas the panoramic collector 108 is adapted to receive a return light beam 118 including a reflection of the illumination beam 114 on each area of the set of azimuthally-spaced areas 116 around the axis 104.

Detailed examples of panoramic projectors and panoramic collectors are described in detail further below.

For ease of understanding, FIG. 1A shows a top plan view of the ranging system 100. As illustrated in this specific example, the ranging system 100 has an azimuthal field of illumination of 360 degrees around the axis 104. The set of azimuthally-spaced areas 116 are thus distributed all around the axis 104.

Also in this specific embodiment, the panoramic collector 108 has an azimuthal field of view of 360 degrees around the axis 104 so as to receive return light from all the illuminated areas 116.

Referring back to FIG. 1, the panoramic collector 108 is adapted to collect the return light beam 118 onto a focal area 120 across the axis 104 by redirecting the return light beam 118 onto the focal area 120. Accordingly, in this example, the panoramic collector 108 acts as a panoramic redirector. The array of sensors 110 is positioned at the focal area 120 to receive the return light beam 118 as redirected from the panoramic collector 108. Each sensor 110 of the array is adapted to sense an intensity of the return light beam 118 from illuminated areas 116.

The computing device 112 is configured to operate the panoramic projector 106 and the array of sensors 110 in a synchronized manner which allows to determine range values. Each range value is indicative of the range between the panoramic projector 106 and a target positioned in at least one of the azimuthally-spaced areas 116.

As it will be understood by the skilled reader, the range values can be determined in various ways. For instance, some embodiments include projection of RF-modulated illumination beams with phase detection using each sensor 110 of the array. In this embodiment, the range value can be determined based on a phase difference between a modulated reference signal, similar to a modulated signal projected towards the scene, and a modulated return signal returning from the scene. Some other embodiments include range-gated imagers or full-waveform analysis at the pixel level. In alternate embodiments, direct time-of-flight imagers can be used. For the latter, the range values can be determined based on the time taken by light to travel from the panoramic projector 106 to the illuminated areas 116 and back to the corresponding ToF sensors 110. Other embodiments may also apply. All these embodiments, independently of the method by which they determine the range values, are referred to in the field as time-of-flight (ToF) sensors.

The array of sensors 110 can be provided in the form of ToF sensors and are referred to as ToF sensors 110. Examples of such time-of-flight sensors include i) model EPC660 available to purchase from ESPROS (array of 320 sensors×240 sensors), ii) model S11962-01CR available to purchase from HAMAMATSU (array of 64 sensors×64 sensors), iii) model OPT8241 available to purchase from TEXAS INSTRUMENTS (array of 320 sensors×240 sensors), and iv) model 19K-S3 available to purchase from PMD PHOTONICS® (array of 160 sensors×120 sensors). Other suitable types of sensors or arrays may be provided.

In some embodiments, the computing device 112 is mounted to the housing 102. In some other embodiments, the computing device 112 is provided externally from the housing 102. In these embodiments, the computing device 112 is connected to the panoramic projector 106 and to the array of ToF sensors 110 via a wired connection, a wireless connection or a combination thereof.

As it will be understood by the skilled reader, the housing 112 of the ranging system 100 is optically transparent to the illumination and to the return light. For instance, in some embodiments, the whole housing is made from an optically transparent material. In some other embodiments, the housing includes one or more windows made of optically transparent material to the illumination and to the return light. The one or more windows may span circumferentially all around the axis 104.

For instance, FIG. 1B shows a top plan view of the array of ToF sensors 110 of the ranging system 100 as illuminated by the return light beam 118 redirected by the panoramic collector 108.

In this specific embodiment, an optical intensity pattern in the form of a circle 122 indicates which ones of the ToF sensors 110 are illuminated by the return light beam 118 as redirected by the panoramic collector 108. As it will be understood, the circle 122 is indicative that the panoramic collector 108 has a rotational symmetry, and the width of the circle 122 depends on an elevation divergence angle of the illumination beam.

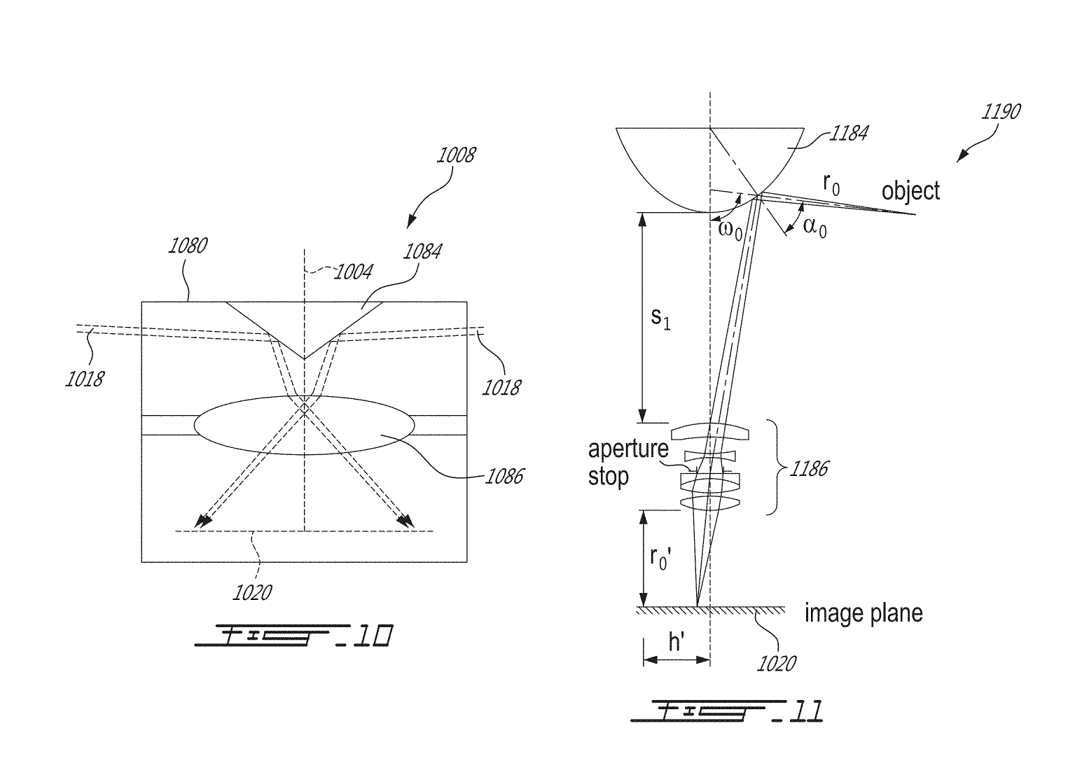

Each illuminated ToF sensor 110 receives a portion of the return light beam 118 associated with a corresponding one of the azimuthally-spaced illuminated areas 116. Therefore, the computing device 112 can determine a range value for each one of the illuminated ToF sensors 110 and assign each range value to a given azimuthal coordinate based on the Cartesian coordinates (e.g., see x- and y-axes) of the illuminated ToF sensors 110 using calibration data. Such calibration data may be stored on a memory of the computing device 112. For instance, FIG. 10 shows exemplary range values plotted as function of the azimuthal coordinate α as determined by the computing device 112.

The ranging system 100 can be adapted to illuminate only a given field of view as required for a specific application, which may save power compared to a ranging system adapted to illuminate not only areas but also a surrounding of the areas. For instance, the panoramic projector 106 has a circular field of illumination to illuminate the azimuthally-spaced areas 116 therearound. Accordingly, the ranging system 100 does not provide unnecessary illumination to a surrounding of the azimuthally-spaced areas 116.

Further, it is noted that the ranging system 100 can provide range values of all the azimuthally-spaced areas 116 simultaneously compared to a ranging system adapted to scan each area one by one using movable parts (e.g., rotatable mirrors).

Although the specific example described with reference to FIG. 1 shows that the panoramic projector 106 has an azimuthal field of illumination of 360 degrees, it is envisaged that the panoramic projector 106 can have an azimuthal field of illumination of less than 360 degrees. For instance, the azimuthal field of illumination can be 180 degrees, 90 degrees or 45 degrees. Other embodiments may apply.

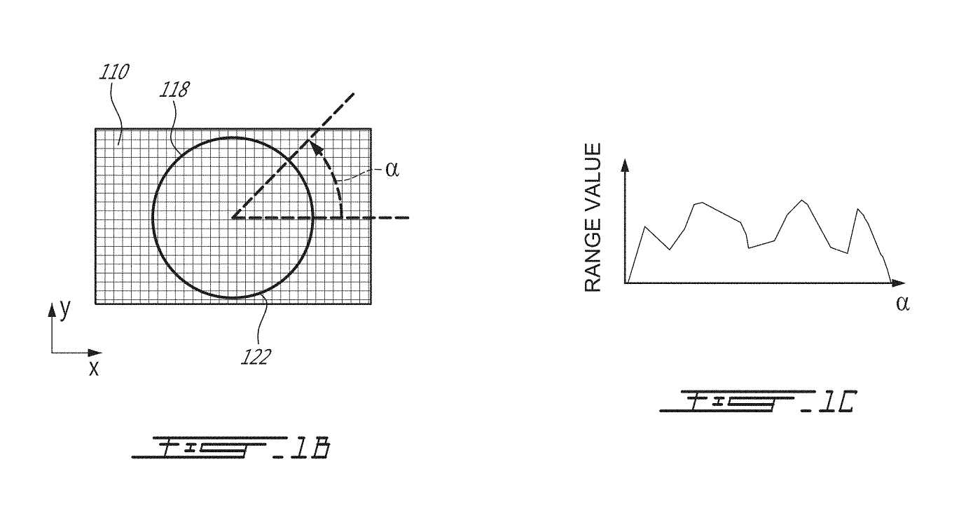

For instance, FIG. 2 shows a top plan view of an example of a ranging system 200. As depicted, a panoramic projector 206 of the ranging system 200 has a first field of illumination spanning between first azimuthal coordinate α1 and second azimuthal coordinate α2 wherein the difference between the first azimuthal coordinate α1 and the second azimuthal coordinate α2 is less than 360 degrees, i.e. Δα=α2−α1<360 degrees. In this example, the difference Δα is about 45 degrees. However, the difference Δα may vary in alternate embodiments.

Such a limited azimuthal field of illumination can generally cause illumination of a lesser number of ToF sensors 110 compared to the embodiment shown in FIG. 1. For instance, FIG. 2A shows an optical intensity pattern in the form of a first arc 222a indicating which ones of the ToF sensors 110 are illuminated. Accordingly, a computing device of the ranging system 200 can determine range values for each azimuthal coordinate α between the first azimuthal coordinate α1 and the second azimuthal coordinate α2, as shown in FIG. 2B.

In some embodiments, the panoramic projector 206 can have more than one azimuthal field of illumination. For instance, still referring to FIG. 2, the panoramic projector 206 has a second azimuthal field of illumination spanning between a third azimuthal coordinate α3 and a fourth azimuthal coordinate α4.

FIG. 2A shows an optical intensity pattern in the form of a second arc 222b which indicates which ones of the ToF sensors 110 are illuminated. As it can be seen in FIG. 2B, the computing device can determine range values for each azimuthal coordinate between the third azimuthal coordinate α3 and the fourth azimuthal coordinate α4.

In this embodiment, the ranging system 200 has a panoramic collector having an azimuthal field of view of 360 degrees so as to receive return light from illuminated ones of the azimuthally-spaced areas 216 of both the first and second fields of illumination.

In some embodiments, the panoramic collector may have a first azimuthal field of view corresponding to the first azimuthal field of illumination and a second azimuthal field of view corresponding to the second azimuthal field of illumination.

In some other embodiments, the panoramic projector may have a plurality of fields of illumination azimuthally-spaced apart from one another, and the panoramic collector may have one or more fields of view corresponding to the plurality of fields of illumination. Other embodiments may apply.

Although the specific example described with reference to FIG. 1 shows that the illumination beam 114 has a first elevation angle Θ1 in-plane relative to the plane perpendicular to the axis 104 (i.e. Θ1=0 degree), it is envisaged that the first elevation angle Θ1 can vary.

In some embodiments, the panoramic projector is adapted to project a plurality of illumination beams at a plurality of elevation angles Θ towards a plurality of sets of azimuthally-spaced areas. In these embodiments, the panoramic collector is adapted to redirect, on the focal area, a plurality of return light beams from reflections of the plurality of illumination beams on each of the plurality of sets of azimuthally-spaced areas.

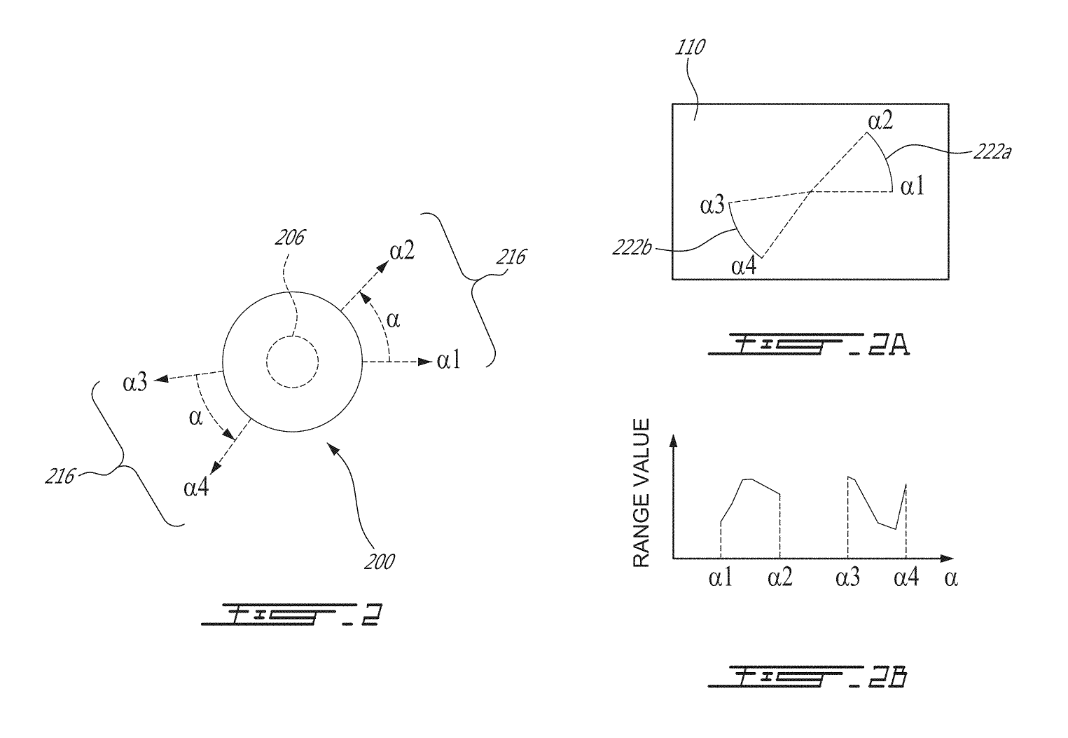

For instance, FIG. 3 shows a side elevation view of another example of a ranging system 300. As depicted, a panoramic projector 306 is adapted to provide a first illumination beam 314a at a first elevation angle Θ1 and a second illumination beam 314b at a second elevation angle Θ2, different from the first elevation angle Θ1.

In this case, the panoramic collector 308 receives a first return light beam 318b at the first elevation angle Θ1 and a second return light beam 318a at the second elevation angle Θ2. In this embodiment, the panoramic collector 308 collects the first return light beam 318a and the second return light beam 318b and redirects them onto the focal area 320 as shown in FIG. 3A. Accordingly, in this example, the panoramic collector 308 acts as a panoramic redirector.

As shown, the panoramic collector 308 has a circular symmetry. Accordingly, FIG. 3A shows an optical intensity pattern in the form of a first circle 322a which indicates which ones of the ToF sensors 310 are illuminated by the first return light beam 318a. FIG. 3A also shows another optical intensity pattern in the form of a second circle 322b which indicates which ones of the ToF sensors 310 are illuminated by the second return light beam 318b as redirected by the panoramic collector 308.

Accordingly, the ranging system 300 can determine range values for each azimuthal coordinate α for the ToF sensors 310 illuminated by both the first return light beam 318a and the second return light beam 318b, as shown in FIG. 3B.

In another embodiment, the illumination is continuous between the first and second azimuthal angles Θ1 and Θ2 such that all the ToF sensors 310 between the first and second circles 322a and 322b can also be used to provide a corresponding range value.

In alternate embodiments, the panoramic projector can be adapted to project a another illumination beam at a single azimuthal coordinate α towards a third plurality of zenithally-spaced (i.e. spaced in elevation) areas provided at different elevation angles Θ.

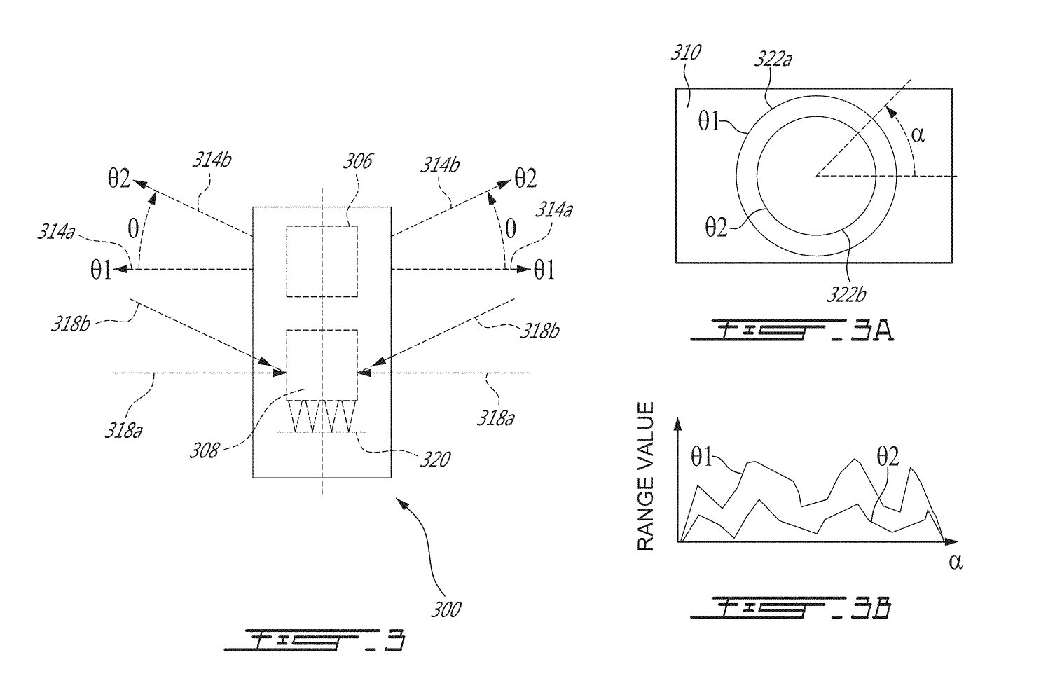

For instance, FIG. 4 shows an example of a ranging system 400. As shown, a first illumination beam 414a is projected at all azimuths around the axis 404 towards azimuthally-spaced areas 416a, and a third illumination beam 414c is projected at a single azimuthal coordinate α0 towards a set of zenithally-spaced areas 416c distributed between a first elevation angle Θ1 and a second elevation angle Θ2.

In this case, the ranging system 400 is adapted to receive a first return light beam from reflection of the first illumination beam 414a on each one of the first set of azimuthally-spaced apart areas 416a and to receive a third return light beam from reflection of the third illumination beam 414c on each one of the set of zenithally-spaced areas 416c.

FIG. 4A shows an optical intensity pattern in the form of a first circle 422a indicating which ones of the ToF sensors 410 are illuminated by the first return light beam whereas a line segment 422c indicates which ones of the ToF sensors 410 are illuminated by the third return light beam.

As it will be understood by the skilled reader, the ranging system may include any of the example panoramic projectors or example panoramic collectors described herebelow. Other examples of panoramic projectors or panoramic collectors may also apply as may be understood by the skilled reader.

Panoramic Projector—Example 1

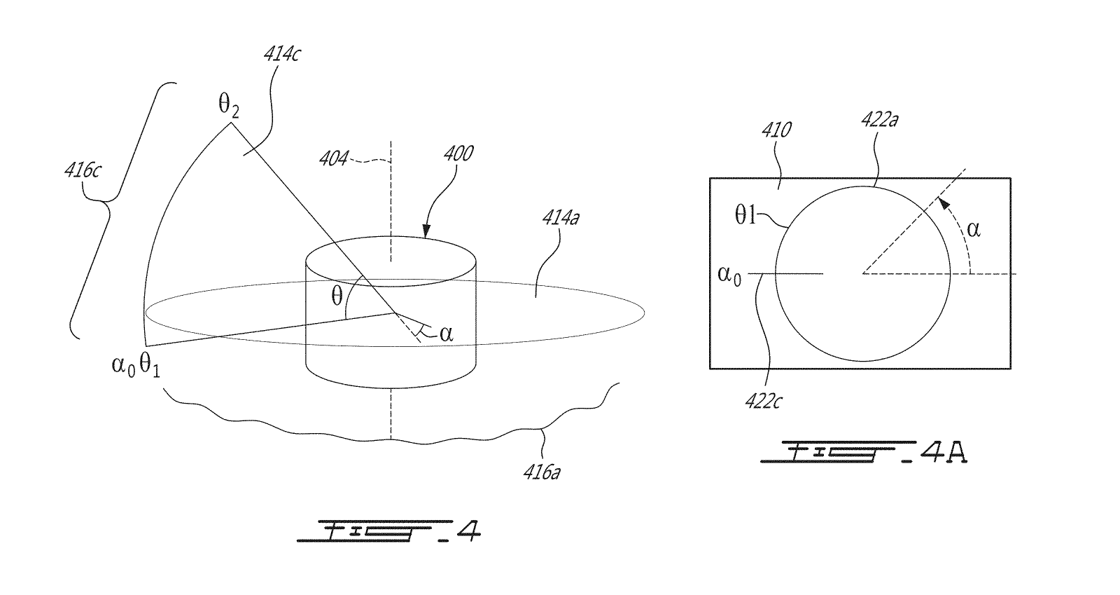

FIG. 5 shows a sectional view of an example of a panoramic projector 506, in accordance with an embodiment. As depicted, the panoramic projector 506 has a frame 530, an axis 504 fixed relative to the frame 530, an optical source 534, a collimating lens 536 and a panoramic reflector 538.

The optical source 534, the collimating lens 536 and the panoramic reflector 538 are mounted to the frame 530 via mounts and fixed relatively to one another via the frame 530. In some embodiments, the frame 530 is provided as part of the housing of a ranging system. In some other embodiments, the frame 530 is separate from the housing of a ranging system and is mountable thereinside.

In some embodiments, the optical source 534 is a vertical-external-cavity surface-emitting-laser (VECSEL) having a center wavelength of 850 nm, an emission area of 0.5 mm×0.5 mm, a numerical aperture of 0.15, a continuous wave (CW) output power of 0.5 W and is mounted encapsulated. However, other embodiments can apply. Any optical source adapted to provide a beam having natural rotational symmetry properties or any optical source whose beam is transformable to achieve a circular shape can be used. The optical source can be a light-emitting diode (LED), a laser diode or a laser to name a few examples.

The optical source 534 is adapted to provide a diverging light beam 540 along the axis 504 and towards the collimating lens 536.

The collimating lens 536 is provided across the axis 504 and downstream relative to the optical source 534 in a manner to receive the diverging light beam 540 from the optical source 534 and to provide a collimated light beam 542 towards the panoramic reflector 538. The collimating lens 536 helps avoid any divergence (i.e. increase in thickness) of the illumination beam 544 as it propagates away from the frame 530.

The panoramic reflector 538 is provided across the axis 504 and downstream relative to the collimating lens 536 such as to receive the collimated light beam 542 and to redirect it into an illumination beam 544 all around the axis 504.

In this example, the panoramic reflector 538 has an apex angle β of 90 degrees. However, the apex angle β can vary. For instance, the apex angle β can be 70 degrees or 110 degrees. Other apex angles β may apply. As it will be understood, an apex angle β of 90 degrees can provide an illumination beam at an elevation angle of 0 degree. Varying the apex angle β in turn varies the elevation angle of the illumination beam.

In embodiments where an azimuthal field of illumination of 360 degrees is desired, the panoramic reflector 538 can include a reflective conical surface.

In embodiments where an azimuthal field of illumination of less than 360 degrees is desired, the panoramic reflector 538 can include a pyramidal body with reflective faces. Such a pyramidal body can have a triangular base, a rectangular base, a square base, a pentagonal base and so forth, depending on the application.

Although the collimating lens 536 and the panoramic reflector 538 are provided as two separate parts, they both may be made integral to one another in a single body of material, as described in the following example.

Panoramic Projector—Example 2

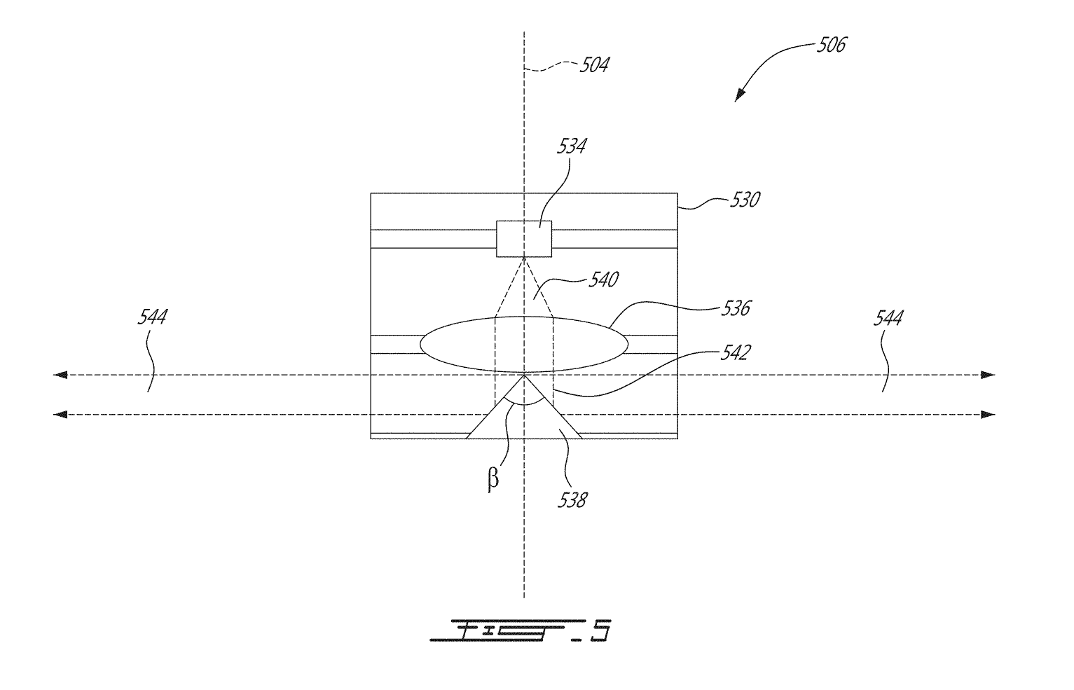

FIG. 6 shows an example of a panoramic projector 606 including an optical source 634 and an integrated panoramic reflector 650 mounted to the frame 630.

As best seen in FIG. 6A, the integrated panoramic reflector 650 has a cylindrical body 652 having a first end 654 and a second end 656. The cylindrical body 652 extends along an axis 604 between the first end 654 and the second end 656. As it will be understood, the cylindrical body 652 is made of an optically transparent material.

The first end 654 has a convex shape 660. The second end 656 has a conical recess 662, and the conical recess 662 has a reflective surface 664. As shown, the convex shape 660 and the conical recess 662 are aligned with one another along the axis 604. The integrated panoramic reflector 650 can be made of a single piece of polymer by injection molding.

Referring back to FIG. 6, the optical source 634 is adapted to provide a diverging light beam 640 along the axis 604 and towards the first end 654 of the cylindrical body 652 of the integrated panoramic reflector 650.

The convex shape 660 is adapted to receive the diverging light beam 640 from the optical source 634 and to collimate it along the axis 604 such as to provide a collimated light beam 642 inside the cylindrical body 652 and towards the second end 656 thereof.

The reflective surface 664 of the conical recess 662 is adapted to reflect the collimated light beam 642 in an illumination beam 644 directed towards azimuthally-spaced areas around the cylindrical body 652.

It was found that the integrated panoramic reflector 650 requires simpler alignment manipulations and provides an increased resistance to vibrations as compared to other types of panoramic projectors such as the panoramic projector 506.

In this example, the conical recess 662 has an apex angle β of 90 degrees. However, the apex angle β can vary. For instance, the apex angle β can be 70 degrees or 110 degrees. Other apex angles β may apply. As mentioned above, an apex angle β of 90 degrees can provide an illumination beam at an elevation angle of 0 degree. Varying the apex angle β in turn varies the elevation angle of the illumination beam.

In some embodiments, the convex shape 660 has a radius of 19.185 mm and a conic constant of 2.67792, a distance between the central point of the convex shape and the apex of the conical recess of 15 mm, and a diameter of 24.8 mm. In some other embodiments, the conical recess 662 is characterized by a sag of Z=A₁·r wherein A₁=1.0 and r=0 to 12.4 mm. In this embodiment, the cylindrical body 652 has a polished circumferential portion 663 adjacent the conical recess 662 to ensure transmission of the illumination beam 644 outside the cylindrical body 652.

In some embodiments, the cylindrical body 652 includes a first material 666 and the recess formed by the conical recess 662 includes a second material 668 different from the first material 666. In these embodiments, the reflective surface 664 is formed by selecting the first and second materials 666 and 668 such that the collimated light beam 642 is reflected around the cylindrical body 652 via total internal reflection at an interface 670 between the first and second materials 666 and 668. For instance, in this embodiment, the first material can include ULTEM 1010 resin while the second material includes air.

In some other embodiments, the reflective surface 664 includes an optical coating configured to reflect a desired wavelength band of the collimated light beam 642.

In the embodiment illustrated in FIG. 6A, a cone angle φ formed between the axis 604 and the conical recess 662 can vary between the apex and the base thereof to provide illumination beams at different elevation angles. For instance, in alternate embodiments, the conical recess of the integrated-panoramic reflector includes more than one conical section superposed to one another, each having a different cone angle φ, to provide illumination at more than one different elevation angle θ. An example of such a conical recess is described in Patent Application Publication Number 2016/0178356 A1.

Panoramic Projector—Example 3

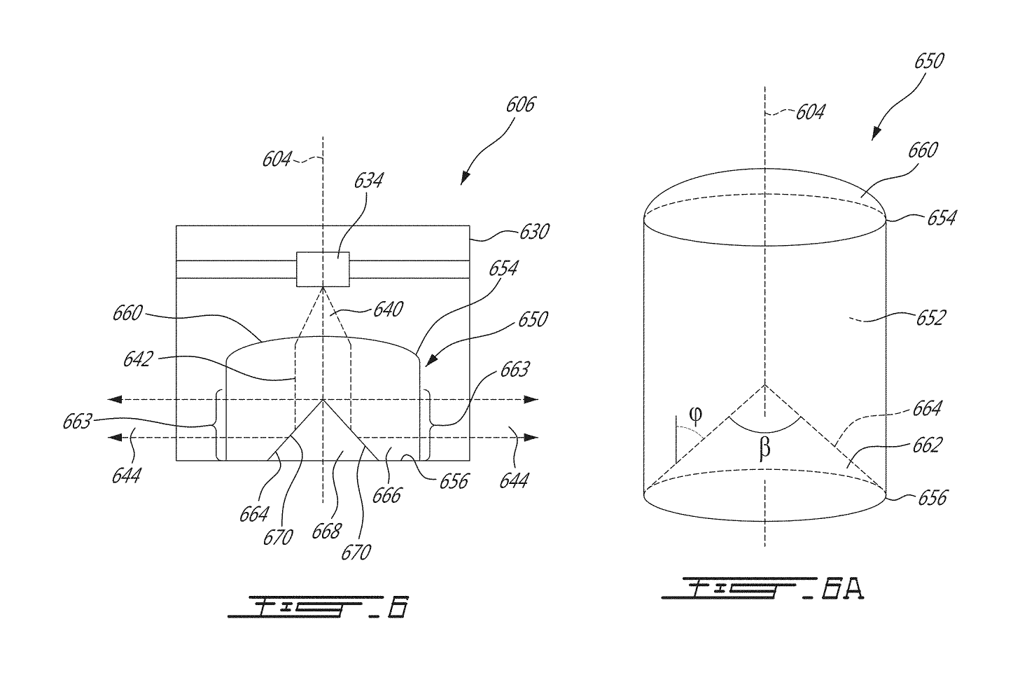

FIG. 7 shows another example of a panoramic projector 706. As depicted, the panoramic projector 706 includes a frame 730, and an optical source 734, a collimating lens 736 and a panoramic reflector 738 mounted to the frame 730.

Similarly to the panoramic projector 506 shown in FIG. 5, the optical source 734, the collimating lens 736 and the panoramic reflector 738 are used to provide a first azimuthal field of illumination all around the axis 704 at a first elevation angle el.

In this specific example, the panoramic projector 706 includes additional optical source(s) 772 mounted to the frame 730 and adapted to provide additional azimuthal field(s) of illumination around the axis 704 but at the second elevation angle Θ2 different from the first elevation angle Θ1.

In this example, there are two additional optical sources 772. However, it is understood that, in other embodiments, the panoramic projector can include a single additional optical source, or more than two additional optical sources, depending on the application.

Panoramic Collector—Example 1

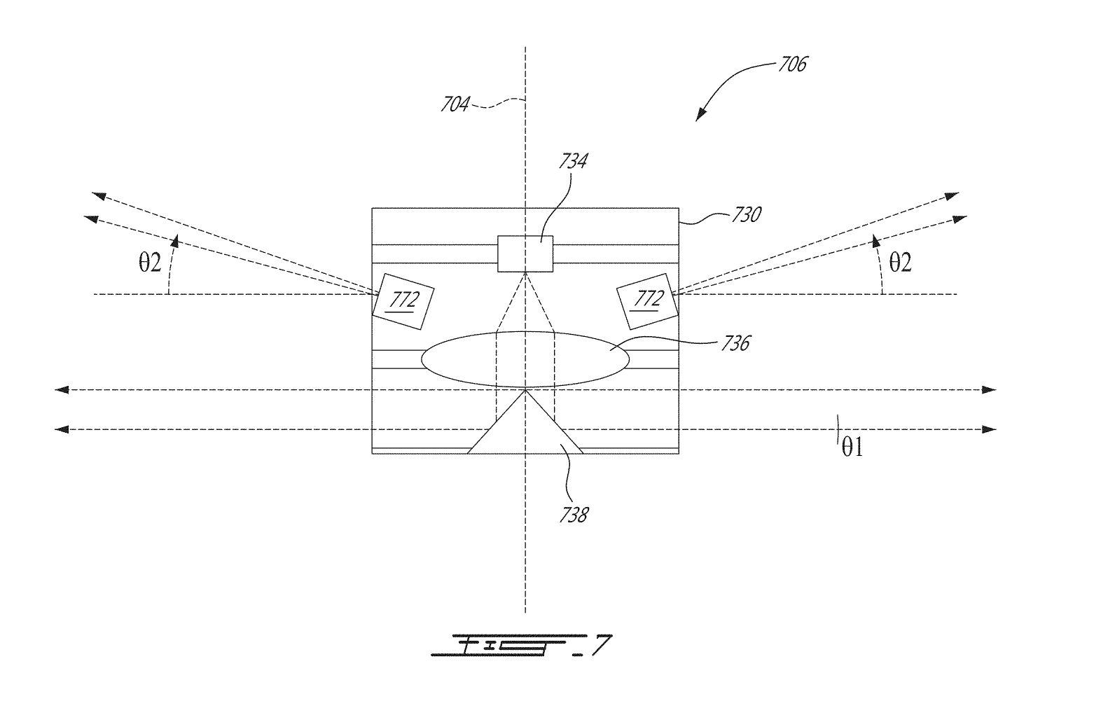

FIG. 8 is a sectional view of an example of a panoramic collector 808. As depicted, the panoramic collector 808 has a frame 880, an axis 804 fixed relative to the frame 880 and a focussing lens assembly 882 mounted to the frame 880.

In some embodiments, the frame 880 is provided as part of the housing of a ranging system. In some other embodiments, the frame 880 is separate from the housing of a ranging system and mountable thereinside.

The focussing lens assembly 882 is adapted to redirect a return light beam 818 and to focus the return light 818 onto the focal area 820 where an array of detectors is to be provided. Accordingly, in this example, the panoramic collector 808 acts as a panoramic redirector.

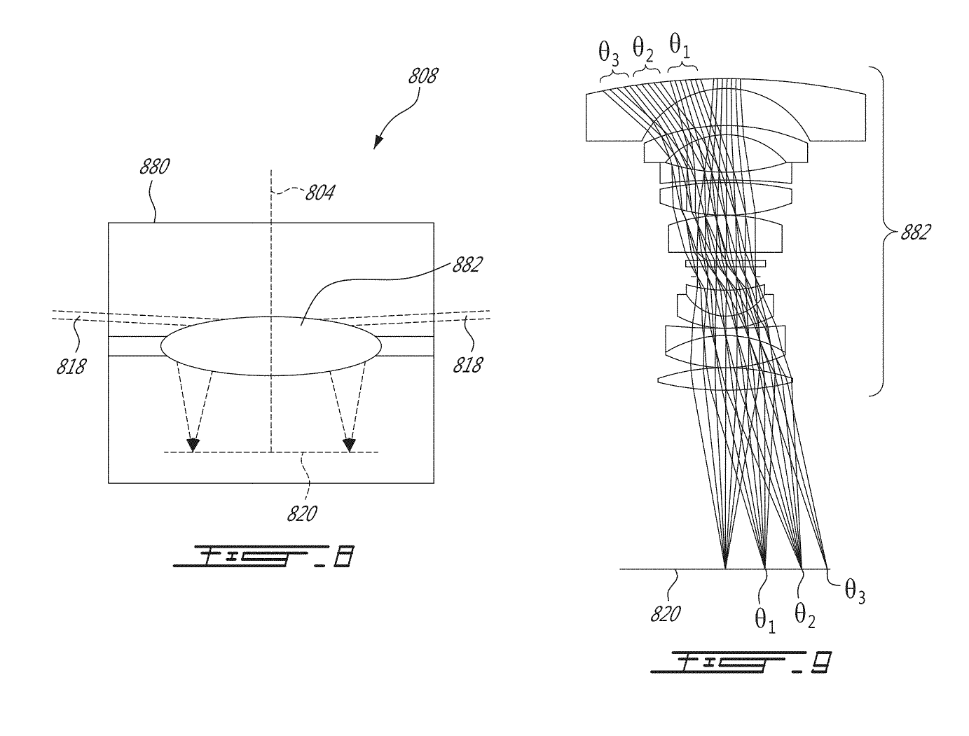

For instance, as shown in FIG. 9, the focussing lens assembly 882 can be embodied by a wide field of view device (e.g., a fish lens device with a field of view of Δθ>180 degrees), a specific example of which is illustrated in FIG. 9. Other embodiment may be applicable.

Panoramic Collector—Example 2

FIG. 10 is a sectional view of another example of a panoramic collector 1008. As depicted, the panoramic collector 1008 has a frame 1080 and an axis 1004 fixed relative to the frame 1080. A panoramic reflector 1084 is provided across the axis 1004 in a manner to receive a return light beam 1018 and to redirect it along the axis 1004 towards a focussing lens assembly 1086. As can be understood, in this example, the panoramic collector 1008 acts as a panoramic redirector. The focussing lens assembly 1086 receives the redirected return light beam and focus it onto the focal area 1020 where an array of detectors may be provided. It is noted that the panoramic reflector 1084 allows the use of a focussing lens assembly 1086 having a narrower field of view as compared to embodiments such as the one shown in FIG. 9.

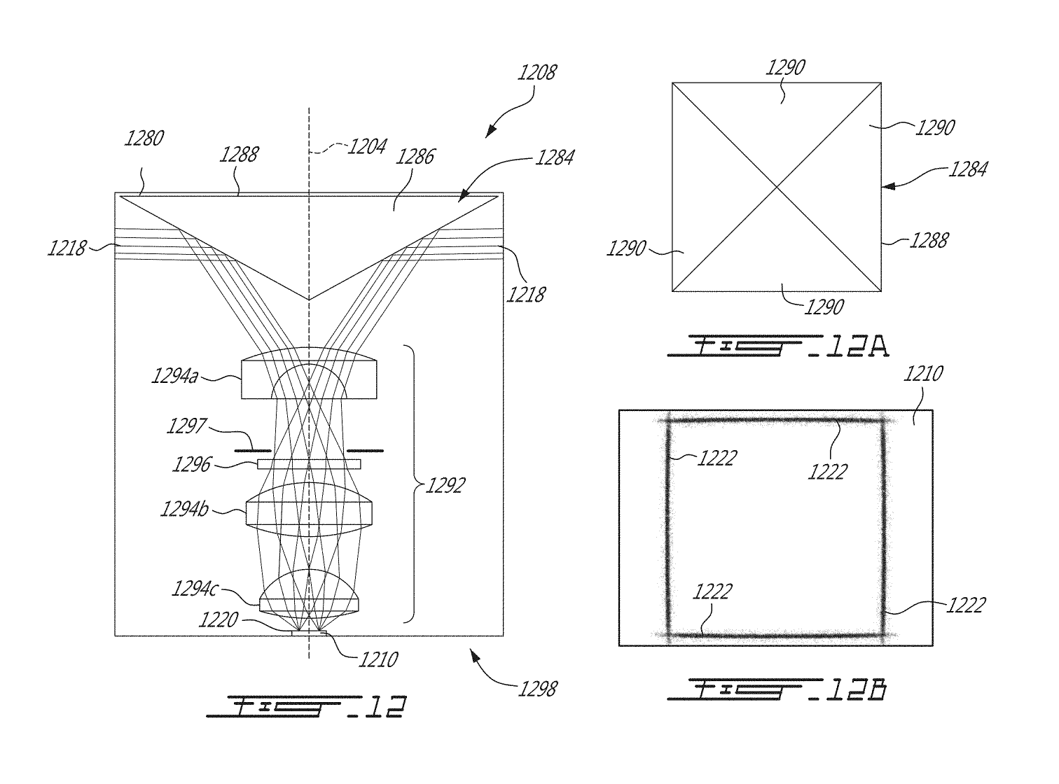

Specific examples of a panoramic reflector and of a focussing lens assembly are shown in FIG. 11. For instance, the panoramic reflector can be provided in the form of a parabolic mirror 1184, and the focussing lens assembly may be embodied by a Tessar lens assembly 1186. Other suitable catadioptric assemblies may be provided.

Panoramic Collector—Example 3

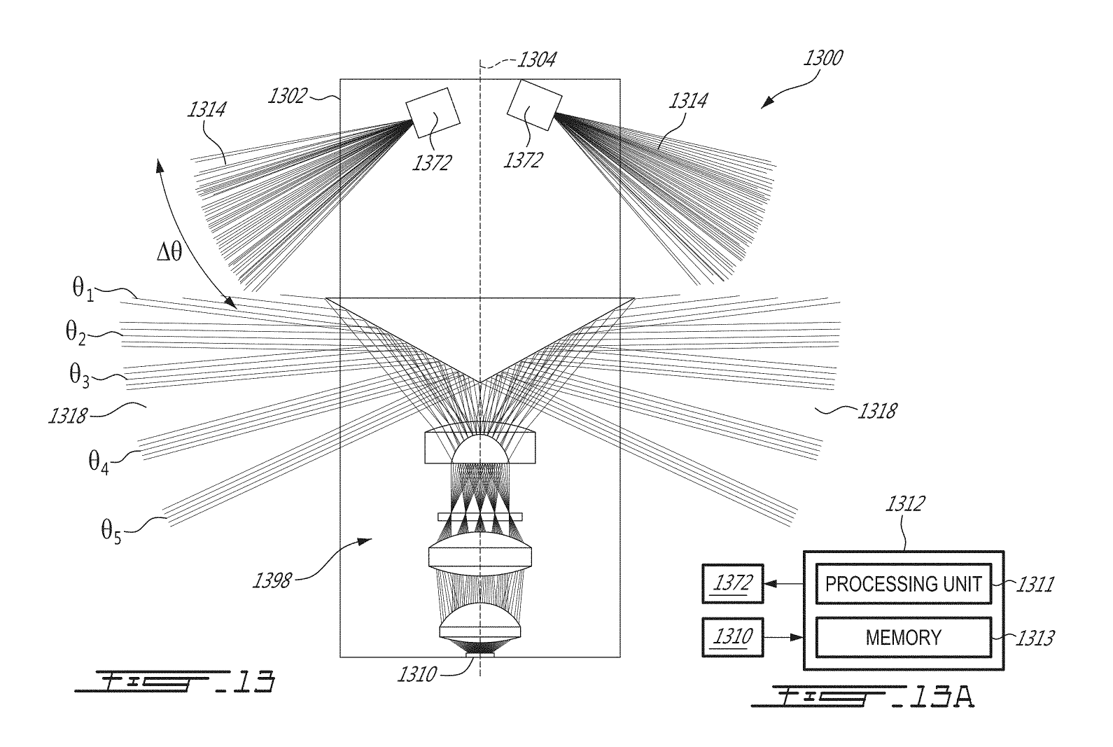

FIG. 12 shows another example of a panoramic collector 1208. As depicted, the panoramic collector 1208 has a frame 1280 and an axis 1204 fixed relative to the frame 1280.

A panoramic reflector 1284 is provided across the axis 1204 to receive a return light beam 1218. In this specific example, the panoramic reflector 1284 includes four reflective lateral faces 1290 arranged in a rectangular pyramidal configuration. In this embodiment, the reflective lateral faces 1290 are made integral to a rectangular pyramidal body 1286 mounted to the frame 1280 and having a base 1288 positioned across the axis 1204. In this specific embodiment, the base 1288 is a square base, as best seen in FIG. 12A. In this example, the four reflective lateral faces 1290 are adapted to receive the return light beam 1218 from a corresponding one of four azimuthal fields of view around the frame 1280 and to redirect the received light along the axis 1204. Accordingly, in this example, the panoramic collector 1208 acts as a panoramic redirector. As it will be understood, in alternate embodiments, the four reflective lateral faces can be part of an optically transparent body, in which the reflective inner faces are recessed in the optically transparent body. Other embodiments may apply.

In this embodiment, the four reflective lateral faces 1290 are flat lateral faces, each edge of the base 1288 has a length of 66 mm, the rectangular pyramidal body 1286 has a height of 17.91 mm perpendicular to the base 1288, and each of the four reflective lateral faces 1290 forms a slant angle of 28.5 degrees relatively to the base 1288. The reflective lateral faces 1290 can have a reflective coating such as a silver or a gold coating deposited thereon. As will be understood, in this example, the rectangular pyramidal body has a square base.

In some embodiments, the rectangular pyramidal body 1286 includes ULTEM 1010 material. In some other embodiments, the rectangular pyramidal body 1286 includes optical grade polymer. Other material may apply. Other suitable embodiments of the rectangular pyramidal body can be used.

Referring back to FIG. 12, a focussing lens assembly 1292 is provided across the axis 1204 and downstream relatively to the panoramic reflector 1284. The focussing lens assembly 1292 is adapted to receive the return light beam 1218 as reflected by the panoramic reflector 1284 and to focus it onto the focal area 1220.

For instance, the focussing lens assembly 1292 includes a combination of a first focussing lens 1294a, a second focussing lens 1294b and a third focussing lens 1294c. Other suitable embodiments may include more or less lens(es).

It was found that use of the panoramic reflector 1284 can allow maintenance of a same entrance pupil diameter notwithstanding the elevation angle of the return light beam. Indeed, the reflective lateral faces 1290 have no optical power because of their respective flatness, the effective aperture is constant over all the elevation field of view and can correspond to the effective aperture of the focussing lens assembly 1292. This can be an advantage over the use of fisheye lenses that display an effective entrance pupil diameter that varies with respect to the elevation angle from aberrations along the elevation field of view.

As depicted, the first focussing lens 1294a is provided across the axis 1204 and downstream relatively to the panoramic reflector 1284.

The second focussing lens 1294b is provided across the axis 1204, downstream relatively to the first focussing lens 1294b and upstream relatively from the third focussing lens 1294c.

The third focussing lens 1294c is provided across the axis 1204 and downstream relatively to the second focussing lens 1294b.

A band pass filter may be provided between the panoramic reflector 1284 and the focal area 1220. For instance, a band pass filter 1296 is provided between the first focussing lens 1294a and the second focussing lens 1294b. In an embodiment, the band pass filter 1296 is positioned at the aperture stop location, where the angle of incidence of the return light beam is minimum. This way, filters based on optical coatings can be used to improve the overall optical transmission within the passband while reducing the drawbacks associated to wide incidence angles spread that reduces the transmission at wanted wavelengths while increasing the transmission of unwanted wavelengths. This position of the filter at the aperture stop can thus be preferred compared to embodiments providing the band pass filter closer to the focal area 1220. It is noted that when the illumination beam includes a narrow wavelength band, the band pass filter 1296 may be a narrow band-pass filter to reduce the amount of ambient light (e.g. not modulated) incident on the array of ToF sensors 1210.

A physical aperture 1297 is mounted to the frame at the location of the aperture stop of the focussing lens assembly 1292 to reduce stray light and increase a resolution of thereof.

The design of the focussing lens assembly 1292 is based on the size of the focal area 1220. For instance, an example of the focussing lens assembly 1292 designed for a focal area of 4.8 mm×3.6 mm is described in the following paragraphs.

In some embodiments, the first focussing lens 1294a has a first lens surface having an EVENASPH type, a radius of −41.93 mm, a thickness of 3 mm, a diameter of 23.6 mm, a conic constant of 9.73932 and aspheric coefficients A₄₀=−6.031E−5, A₆₀=1.126E−6, A₈₀=−8.485E−9 and A₁₀=3.00E−11. In some other embodiments, the first focussing lens 1294a has a second lens surface having a STANDARD type, a radius of −0.5 mm, a thickness of 16 mm, a diameter of 13 mm and a conic constant of −0.6538. In these embodiments, the first focussing lens 1294a includes ULTEM 1010 material. Other embodiments of the first focussing lens may also apply.

In some embodiments, the second focussing lens 1294b has a first lens surface having a STANDARD type, a radius of −14.539, a thickness of 9.63 mm, a diameter of 22.0 mm, and a conic constant of −3.7129. In some other embodiments, the second focussing lens 1294b has a second lens surface having an EVENASPH type, a radius of 34.830 mm, a thickness of 5.11 mm, a diameter of 20.0 mm, a conic constant of 10.5764 and aspheric coefficients of A₄₀=2.412E−4, A₆₀=−4.525E−6, A₈₀=3.48E−8 and A₁₀=−1.58E−10. In these embodiments, the second focussing lens 1294b includes ULTEM 1010 material. Other embodiments of the second focussing lens may also apply.

In some embodiments, the third focussing lens 1294c has a first lens surface having an EVENASPH type, a radius of −6.553 mm, a thickness of 8.81 mm, a diameter of 17.4 mm, a conic constant of −1.0062 and an aspheric coefficient of A₄₀=9.023E−5. In some other embodiments, the third focussing lens 1294c has a second lens surface having an EVENASPH type, a radius of 12.834 mm, a thickness of 2.34 mm (including a cover glass of CCD), a diameter of 17.4 mm, a conic constant of −34.183 and aspheric coefficients of A₄₀=2.816E−4, A₆₀=−9.775E−6, A₈₀=1.664E−7 and A₁₀=−1.12E−9. In these embodiments, the third focussing lens 1294c includes ULTEM 1010 material. Other embodiments of the third focussing lens may also apply.

In some embodiments, the band pass filter 1296 has surfaces having STANDARD type, an infinite radius, a thickness of 2.0 mm and a diameter of 18.0 mm. In these embodiments, the band pass filter 1296 includes N-BK7 material. Other embodiments may also apply. Other embodiments may include more than one filter positioned across the axis 1204. The band pass filter optical characteristics are adapted to the light source and are selected to match the emission wavelengths with a maximum transmission while rejecting other wavelengths with a maximum efficiency. However, the acceptance angles of the filter can be preferably adapted to the position of the filter in the optical train to make sure that its performance will not be reduced.

It was found that a resolution of 15 to 30 μm can be obtained in the horizontal direction (i.e. 0 degree elevation) using the focussing lens assembly 1292. Other suitable focussing lens assemblies can be used.

As it will be understood, the panoramic collector 1208 can be part of a panoramic ToF sensor assembly 1298 when a rectangular array of ToF sensors 1210 is mounted to the frame 1280 at the focal area 1220.

FIG. 12B shows a top plan view of the rectangular array of ToF sensors 1210 as illuminated by the panoramic collector 1208. For instance, in this specific embodiment, each of the fields of view of the panoramic collector 1208 yields an optical intensity pattern in the form of a substantially linear arc segments 1222. The arcs 1222 can collectively form a square wherein each side of the square covers an azimuthal extent of less than 90 degrees in this particular embodiment.

It was found that use of the panoramic reflector 1284 optimizes the distribution of the return light beam onto the rectangular array of ToF sensors 1210 and improves the azimuthal resolution compared to panoramic ToF sensor assemblies having rotationally-symmetric panoramic reflectors such as panoramic projectors 506, 606 and 706, for instance. Indeed, such arcs 1222 allows for a more efficient use of the ToF sensors 1210. The square shape produced by the use of the panoramic collector 1208 can improve the angular resolution by about 27% compared to embodiments including a circularly-symmetric reflector that provide an optical intensity pattern in the form of a circle that covers the full wideness of the rectangular array of ToF sensors 1210.

In some embodiments, the panoramic ToF sensor assembly 1298 can be part of a ranging system when used along with any of the panoramic projectors and with the computing device described above.

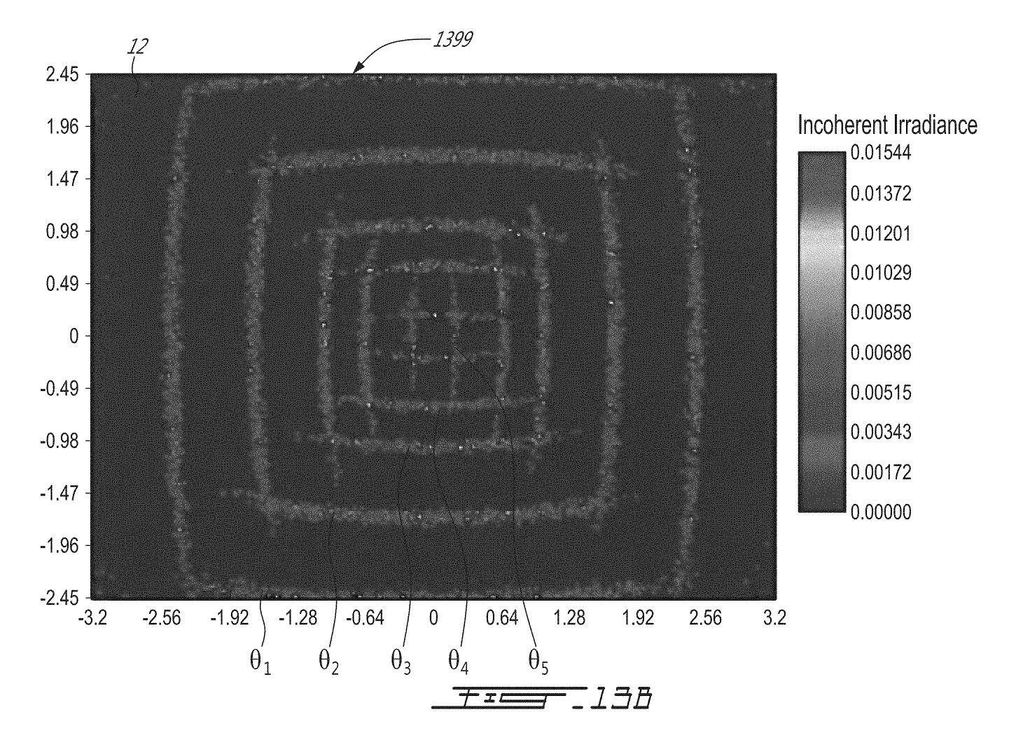

For instance, FIG. 13 shows an example of a ranging system 1300 including a housing 1302 and an axis 1304 fixed relative to the housing 1302.

The ranging system 1300 has a panoramic ToF sensor assembly 1398, similar to the panoramic ToF sensor assembly 1298 of FIG. 12, provided across the axis 1304, and a plurality of optical sources 1372 adapted to provide a plurality of illuminations beams around the axis 1304.

As depicted, the plurality of illuminations beams 1314 are directed towards a plurality of elevation angles Δθ, and the panoramic ToF sensor assembly 1398 is adapted to receive return light beams 1318 including a reflection of the plurality of illumination beams 1314 on each one of a plurality of azimuthally- and zenithally-spaced areas around the axis 1304, and to redirect the redirected return light beam onto the rectangular array of detectors 1310. In other words, the panoramic ToF sensor assembly 1398 has a plurality of azimuthal fields of view spanning at different elevation angles θ. In this specific embodiment, the ranging system 1300 is adapted to provide illumination and to receive return light at elevation angles ranging between θ1=−5 degrees to θ5=30 degrees.

As best seen in FIG. 13A, a computing device 1312 is configured to operate the optical sources 1372 and the rectangular array of ToF sensors 1310.

More specifically, FIG. 13A shows a schematic representation of the computing device 1312, as a combination of software and hardware components. In this example, the computing device 1312 is illustrated with one or more processing units (referred to as “the processing unit 1311”) and one or more computer-readable memories (referred to as “the memory 1313”) having stored thereon program instructions configured to cause the processing unit 1311 to generate one or more outputs based on one or more inputs. The inputs may comprise one or more signals representative of the time at which a pulse is emitted, the modulation frequency of the illuminated beam and the like. The outputs may comprise one or more signals representative of the range values associated with each ToF sensor.

The processing unit 1311 may comprise any suitable devices configured to cause a series of steps to be performed so as to implement computer implemented methods for determining the range values, calibrating, filtering, correcting, mapping and the like, when executed by the computing device 1312 or other programmable apparatuses, may cause the functions/acts/steps specified in the methods described herein to be executed. The processing unit 1311 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 1313 may comprise any suitable known or other machine readable storage medium. The memory 1313 may comprise non-transitory computer readable storage medium such as, for example, but not limited to, an electronic, magnetic, optical, electromagnetic, infrared, or semiconductor system, apparatus, or device, or any suitable combination of the foregoing. The memory 1313 may include a suitable combination of any type of computer memory that is located either internally or externally to the device such as, for example, random-access memory (RAM), read-only memory (ROM), compact disc read-only memory (CDROM), electro optical memory, magneto-optical memory, erasable programmable read-only memory (EPROM), and electrically-erasable programmable read-only memory (EEPROM), Ferroelectric RAM (FRAM) or the like. Memory 1313 may comprise any storage means (e.g., devices) suitable for retrievably storing machine-readable instructions executable by the processing unit 1311.

Each computer program described herein may be implemented in a high level procedural or object-oriented programming or scripting language, or a combination thereof, to communicate with an external computer. Alternatively, the programs may be implemented in assembly or machine language. The language may be a compiled or an interpreted language. Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

FIG. 13B shows a top plan view of a range image 1399 that can be provided by the ranging system 1300, in accordance with an embodiment. As depicted, some pixels of the range image are associated with range values corresponding to azimuthally-spaced areas at a first elevation angle Θ1, some pixels of the range image are associated with range values corresponding to azimuthally-spaced areas at a second elevation angle Θ2 and so forth. As it can be appreciated, the range image 1399 covers a physical angular coverage of 360 degrees in the azimuthal coordinates per 35 degrees in the elevation coordinates.

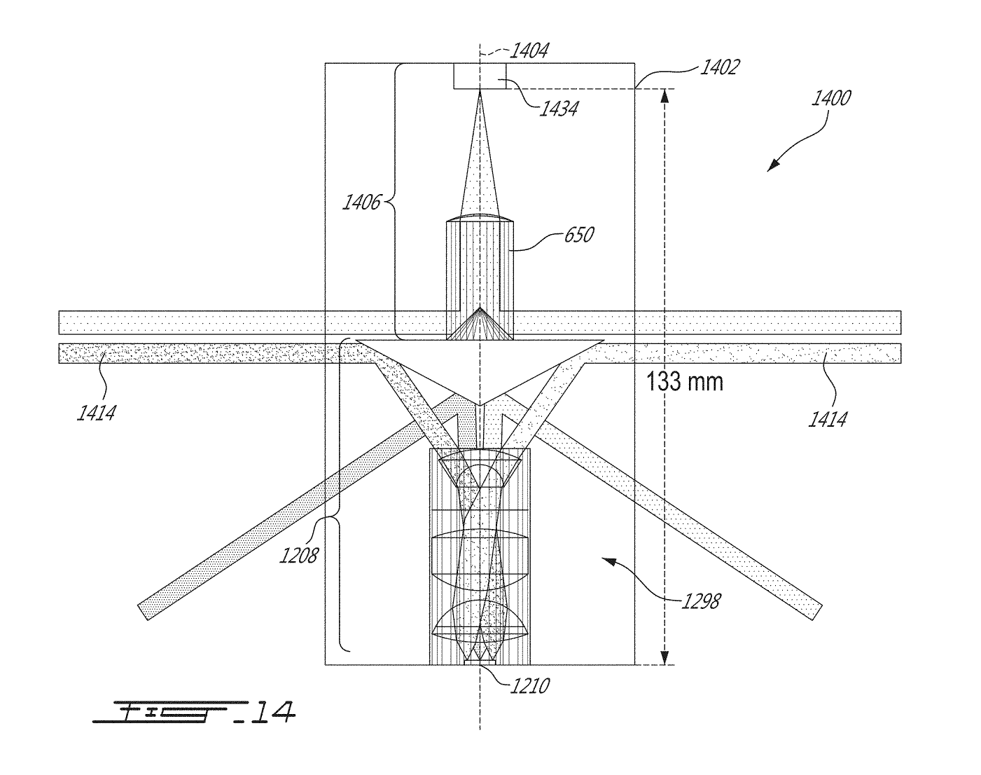

FIG. 14 shows a side elevation view of an example of a ranging system 1400. As depicted in this specific example, the ranging system 1400 has a housing 1402, an axis 1404, a panoramic illuminator 1406 including an optical source 1434 optically coupled to the integrated panoramic reflector 650, and the panoramic ToF sensor assembly 1298 including the panoramic collector 1208 and the rectangular array of ToF sensors 1210.

In this specific embodiment, the optical source 1434 and the focal area 1210 are spaced from 133 mm, the thickness of the illumination beam 1414 is about 5 mm at the output, the entrance pupil diameter of the integrated panoramic reflector 650 is about 5 mm.

Panoramic Projector—Example 4

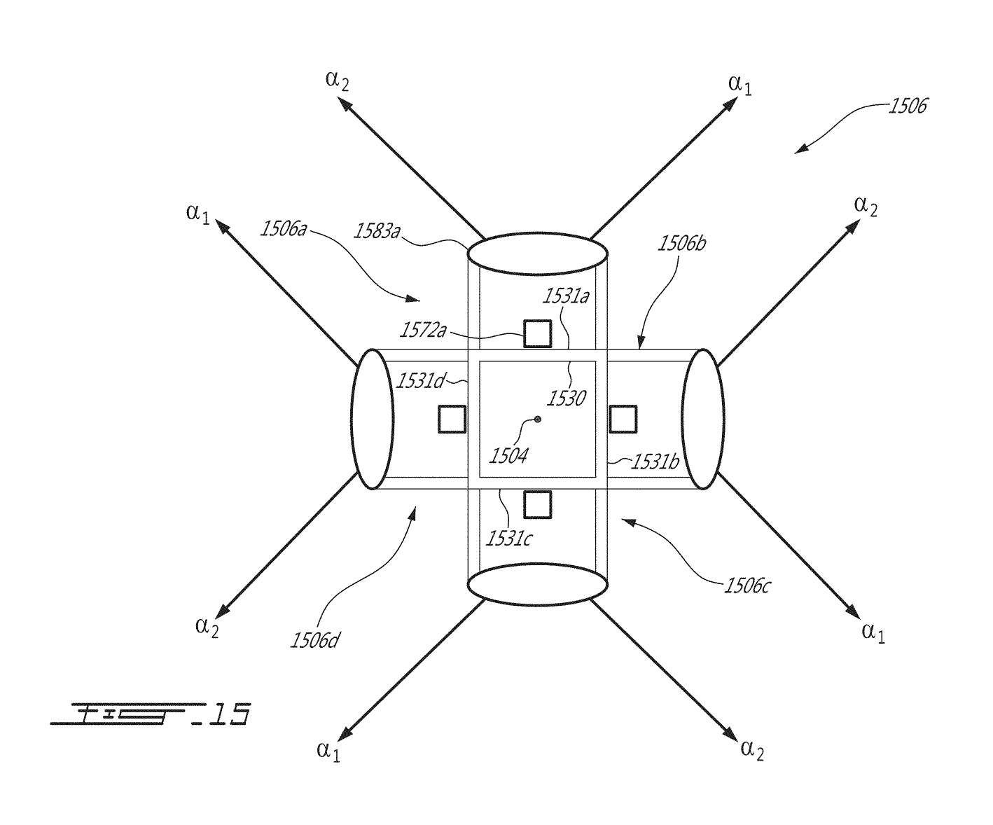

FIG. 15 is a top view of an example of a panoramic projector 1506, in accordance with an embodiment. As depicted, the panoramic projector 1506 has a frame 1530 and an axis 1504 fixed relative to the frame 1530. The panoramic projector 1506 comprises optical sources mounted to the frame 1530 and which face away from the axis 1504. These optical sources are adapted to project illumination beams away from the axis 1504. A plurality of projection lens assemblies are mounted to the frame 1530 so as to project corresponding ones of the illumination beams towards different sets of azimuthally-spaced areas around the axis 1504. As will be understood, one optical source and its corresponding projection lens assembly are referred to as a “projector sub assembly”.

More specifically, in this example, the frame 1530 has four faces 1531a, 1531b, 1531c and 1531d, which are parallel to, and spaced from the axis 1504. In alternate embodiments, however, the frame 1530 can have three faces, or more than four faces, depending on the embodiment. As shown, the panoramic projector 1506 has a projector sub assembly 1506a which is mounted to the face 1531a of the frame 1530 via mounts. The projector sub assembly 1506a has an optical source 1572a and a projector lens assembly 1583a which are mounted to the face 1531a. The optical source 1572a is adapted to provide an illumination beam towards the projector lens assembly 1583a in order to illuminate a corresponding azimuthal field of illumination. In this example, the azimuthal field of illumination spans from a first azimuthal coordinate α1 to a second azimuthal coordinate α2 around the axis 1504.

Similarly, projector sub-assemblies 1506b, 1506c and 1506d are mounted to corresponding ones of the other faces 1531b, 1531c and 1531d of the frame 1530. The projector sub-assemblies 1506b, 1506c and 1506d are similar to the projector sub assembly 1506a described above. Accordingly, the fields of illumination of the projector sub-assemblies 1506a, 1506b, 1506c and 1506d are perpendicular to the axis 1504.

In embodiments where ranging in a plan which is perpendicular to the axis 1504 is desired, the projector lens assembly 1583a can include a cylindrical lens, a Powell lens and/or a holographic line diffuser that can project a line beam over the desired azimuthal positions in a desired plan. Moreover, in embodiments where targets should not be missed, multiple projector sub-assemblies with overlapping extended fields of illumination for azimuthal and elevational ranging can be used. In these embodiments, multiple optical sources can be projected in a same field of illumination to provide more power to the illumination beam.

Panoramic Collector—Example 4

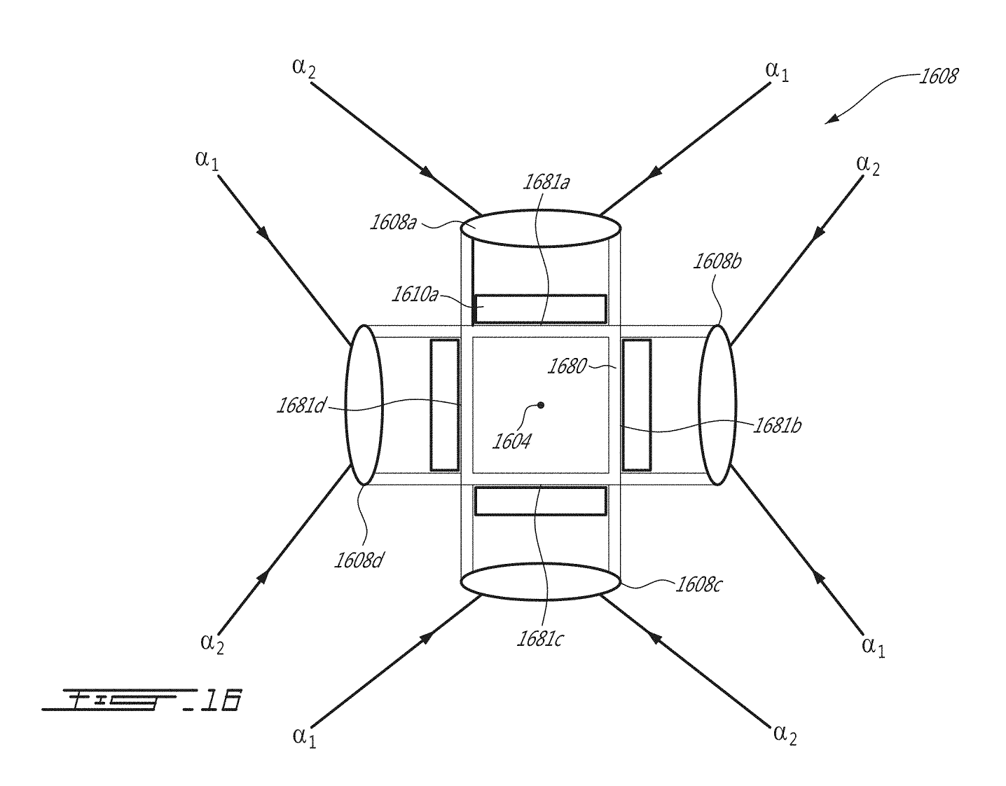

FIG. 16 is a top view of an example of a panoramic collector 1608, in accordance with an embodiment. As depicted, the panoramic collector 1608 has a frame 1680 and an axis 1604 fixed relative to the frame 1680. The panoramic collector 1608 comprises a plurality of collector lens assemblies which are mounted to the frame 1680 and which are adapted to collect corresponding return light beams on corresponding arrays of ToF sensors.

In this example, the frame 1680 has four faces 1681a, 1681b, 1681c and 1681d which are parallel to the axis 1604. In alternate embodiments, however, the frame 1680 can have three faces, or more than four faces depending on the embodiment.

As shown, the panoramic collector 1608 includes a collector lens assemblies 1608a mounted to the face 1681a of the frame 1680 via mounts. The collector lens assemblies 1608a is adapted to collect a return light beam, incoming from an azimuthal field of view, on a corresponding focal plane which is parallel to and spaced from the axis 1604 in this example. As shown, an array of ToF sensors 1610a is positioned on the corresponding focal plane. In this embodiment, the azimuthal field of view spans from a first azimuthal coordinate α1 to a second azimuthal coordinate α2 around the axis 1604. The azimuthal field of view can be a narrow field of field.

Similarly, collector lens assemblies 1608b, 1608c and 1608d are mounted to corresponding ones of the other faces 1681b, 1681c and 1681d of the frame 1680. The collector lens assemblies 1608b, 1608c and 1608d are similar to the collector lens assemblies 1608a.

In embodiments where ranging in a plan which is perpendicular to the axis 1604 is desired, the arrays of ToF sensors can have a linear shape extending in the azimuthal plane. Example of such arrays of ToF sensors includes the model S11961-01CR manufactured by Hamamatsu. Further, in embodiments where the return light beam should not be missed, more than one array of ToF sensors with overlapping fields of view or two-dimensional arrays of ToF sensors azimuthal and elevational ranging can be used.

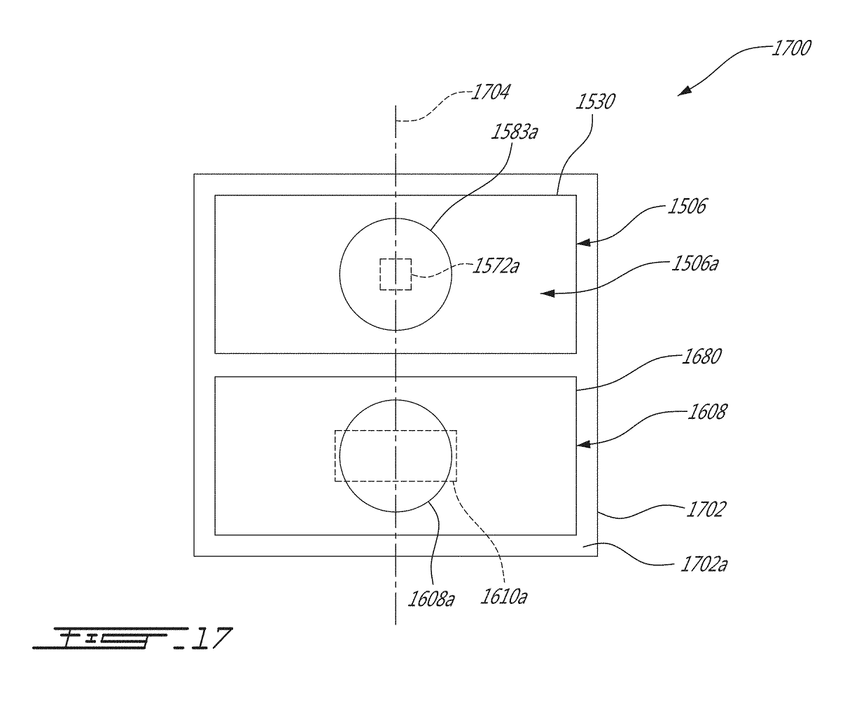

FIG. 17 is a side view of another example of a ranging system 1700, in accordance with an embodiment. As shown, the ranging system 1700 has a housing 1702 and an axis 1704 fixed relative to the housing 1702. In this embodiment, the ranging system 1700 has the panoramic projector 1506 of FIG. 15 and the panoramic collector 1608 of FIG. 16 in a stacked configuration. Accordingly, the azimuthal field of illumination of the panoramic projector 1506 is thus spaced from the azimuthal field of view of the panoramic collector 1608 along the axis 1704.

As depicted in the illustrated embodiment, the housing 1702 has a face 1702a which exposes both the projector sub assembly 1506a and the collector lens assembly 1608a. For instance, the optical source 1572a is adapted to illuminate a corresponding azimuthal field of illumination via the projector lens assembly 1583a and a return light beam is provided onto the array of ToF sensors 1610a via the collector lens assembly 1608a.

As can be understood, each of the other faces of the housing 1702 exposes a corresponding pair of projector sub-assemblies and the collector lens assemblies in a similar fashion.

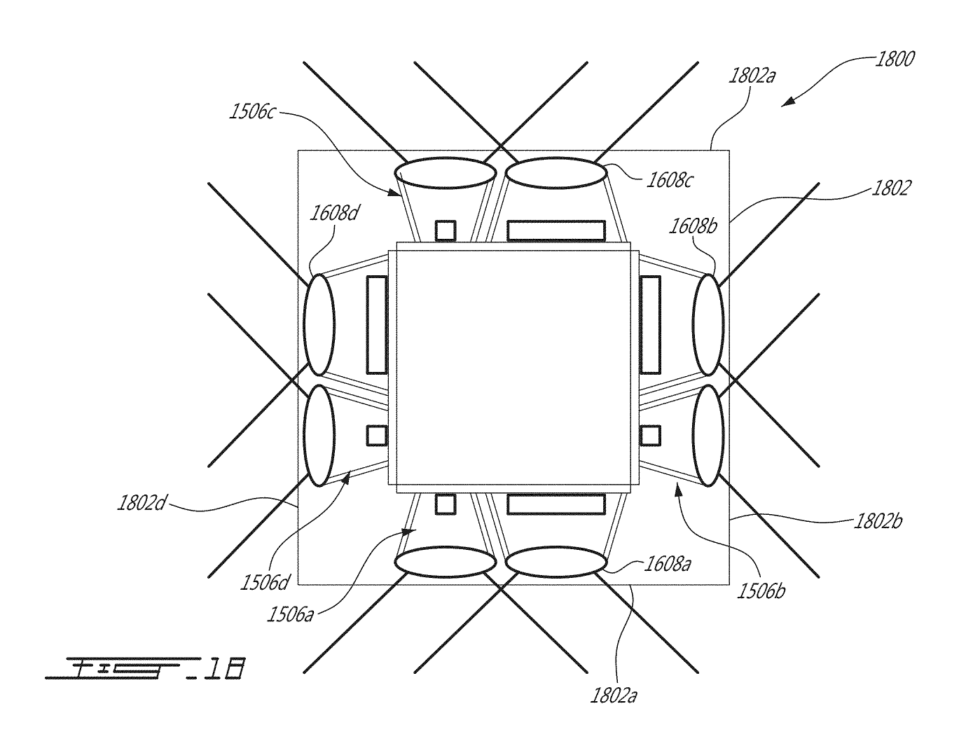

FIG. 18 is a top view of another example of a ranging system 1800, in accordance with an embodiment. As depicted, the ranging system 1800 has a housing 1802 and an axis 1804 fixed relative to the housing 1804. The ranging system 1800 has the panoramic projector 1506 of FIG. 15 and the panoramic collector 1608 of FIG. 16 in a side-by-side configuration. As shown, the field of illumination of the panoramic projector 1506 is coplanar with the field of view of the panoramic collector 1608.

As depicted in the illustrated embodiment, both the projector sub assembly 1506a and the collector lens assembly 1608a are mounted inside the housing 1802 and are oriented towards the face 1802a of the housing 1802, away from the axis 1804. For instance, the optical source 1572a is adapted to illuminate a corresponding field of illumination via the projector lens assembly 1583a and a return light beam is provided onto the array of ToF sensors 1610a via the collector lens assembly 1608a.

As can be understood, projector sub assembly 1506b and collector lens assembly 1608b are oriented towards a face 1802b of the housing 1802, projector sub assembly 1506c and collector lens assembly 1608c are oriented towards a face 1802c of the housing 1802, and projector sub assembly 1506d and collector lens assembly 1608d are oriented towards a face 1802d of the housing 1802.

As shown, each of the four projector sub-assemblies 1506a, 1506b, 1506c and 1506d has an azimuthal field of illumination covering 90 degrees. Correspondingly, each of the four collector lens assemblies 1608a, 1608b, 1608c and 1608d has an azimuthal field of view covering 90 degrees. In this example, the azimuthal fields of illumination of the four projector sub-assemblies 1506a, 1506b, 1506c and 1506d do not overlap and the azimuthal fields of view of the four collector lens assemblies 1608a, 1608b, 1608c and 1608d does not overlap either. However, it might not be the case in alternate embodiments.

As will be understood, the configuration of the ranging system 1800 can vary from an embodiment to another. Indeed, the configuration of the ranging system 1800 can depend on the azimuthally- and/or zenithally-spaced areas to be ranged. For instance, the areas to be ranged can form a line, a ring, a spot around the ranging system 1800.

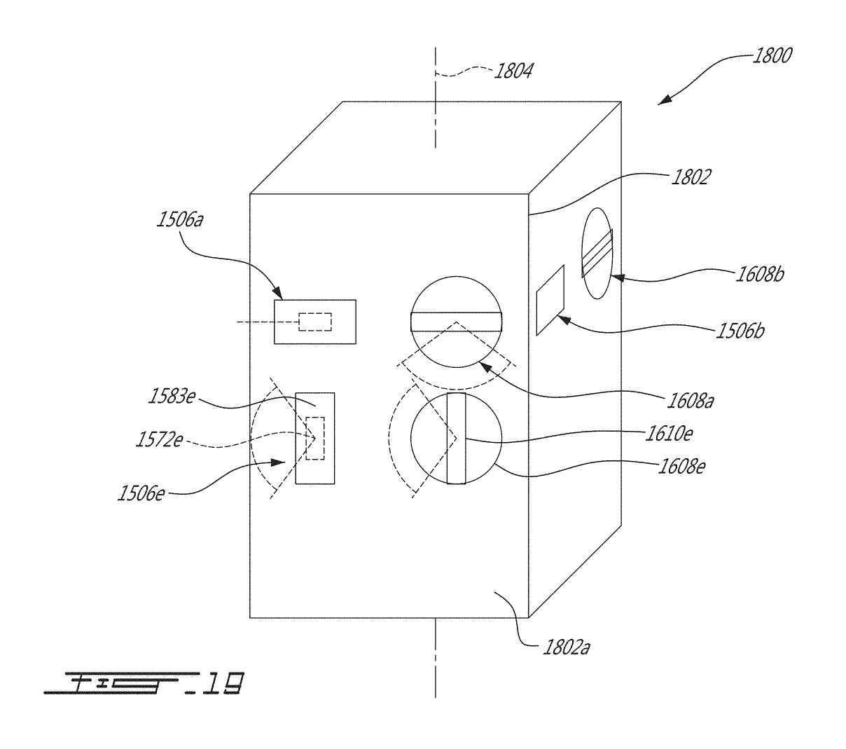

FIG. 19 shows an oblique view of the ranging system 1800. As can be seen, the projector sub assembly 1506a and the collector lens assembly 1608a are oriented towards the face 1802a, and away from the axis 1804. Similarly, the projector sub assembly 1506b and the collector lens assembly 1608b are oriented towards the face 1802b, and away from the axis 1804. However, in this example, one additional projector sub assembly 1506e and one additional collector lens assembly 1608e are provided to the face 1802b, beneath the projector sub assembly 1506a and the collector lens assembly 1608a.

In this embodiment, the additional projector sub assembly 1506e has an optical source 1572e and a projector lens assembly 1583e which collectively provide an elevational field of illumination of 45 degrees. Symmetrically, the additional collector lens assembly 1608e has a collector lens assembly 1685e which provides a return light beam, incoming from an elevational field of view of 45 degrees, onto an array of ToF sensors 1610e. As shown, the array of ToF sensors 1610e is oriented to be parallel to the axis 1804 to suitably receive the return light beam resulting from the projection of an illumination beam by the projector sub assembly 1506e. In this way, the field of illumination of the projector sub assembly 1506e and the field of view of the collector lens assembly 1608e are fairly parallel to one another, and can point to a common area.

As can be understood, the examples described above and illustrated are intended to be exemplary only. For instance, the illumination beam(s) can be provided in the form of spot beams, line beams, ring beams, area beams and curved beams depending on the application. The selection of the illumination beam(s) is based on the optimization of the power spatial distribution in correspondence to the areas that are to be ranged. In some embodiments, restricting the illumination beam(s) only to useful azimuthal and elevation coordinates can make the retrieval of the range values more convenient. This disclosure may be used in robotic applications, in metrology applications and in inspection applications. The panoramic reflector, the panoramic collector and associated lenses may be made from injection molding techniques. In a further embodiment, a single LED or a VCSEL array coupled to an asymmetrical diffuser can provide illumination of 90 degrees in the azimuthal coordinates per 40 degrees in the elevation coordinates, four of them arranged suitably can thus illuminate within 360 degrees in the azimuthal coordinates per 40 degrees in the elevation coordinates. The scope is indicated by the appended claims.

What is claimed is:

1. A ranging system comprising:
a housing;
an axis fixed relative to the housing and defining azimuthal coordinates around the axis;
a panoramic projector mounted to the housing and adapted to project an illumination beam towards azimuthally-spaced areas around the axis;
a panoramic collector mounted to the housing, the panoramic collector being adapted to receive a return light beam from illuminated areas and to collect the return light beam onto at least one focal area;
at least one array of time-of-flight (ToF) sensors mounted to the housing and positioned at the at least one focal area, each ToF sensor of the at least one array being adapted to sense an intensity of the return light beam incoming from the azimuthally-spaced areas; and
a computing device configured to operate the panoramic projector and the at least one array of ToF sensors in a synchronized manner allowing to determine, for each ToF sensor of the at least one array, a range value indicative of the range between the panoramic projector and a target positioned in at least one of the azimuthally-spaced areas.

2. The ranging system of claim 1 wherein the panoramic projector has an azimuthal field of illumination of 360 degrees around the axis, the azimuthally-spaced areas being distributed all around the axis.

3. The ranging system of claim 2 wherein the panoramic collector has an azimuthal field of view of 360 degrees around the axis.

4. The ranging system of claim 1 wherein the panoramic projector has a first azimuthal field of illumination spanning between a first azimuthal coordinate and a second azimuthal coordinate different from the first azimuthal coordinate, the set of azimuthally-spaced areas being distributed between the first and second azimuthal coordinates around the axis.

5. The ranging system of claim 4 wherein the panoramic collector has a first azimuthal field of view spanning between the first azimuthal coordinate and the second azimuthal coordinate.

6. The ranging system of claim 1 wherein the panoramic projector has a plurality of fields of illumination being azimuthally-spaced apart from one another, the panoramic collector having one or more fields of view corresponding to the plurality of fields of illumination.

7. The ranging system of claim 1 wherein the panoramic projector is adapted to project the illumination beam at a first elevation angle in-plane relative to a plane perpendicular to the axis, the panoramic collector having a field of view adapted to receive the return light beam at the first elevation angle.

8. The ranging system of claim 1 wherein the panoramic projector is adapted to project the illumination beam comprising a plurality of illumination beams projected at corresponding elevation angles towards a plurality of sets of azimuthally-spaced areas, the sets of azimuthally-spaced areas being zenithally-spaced from one another, the panoramic collector being adapted to collect corresponding return light beams received from the plurality of sets of azimuthally-spaced areas onto the at least one focal area.

9. The ranging system of claim 1 wherein the panoramic projector is adapted to project the illumination beam comprising a zenithal illumination beam projected at a single azimuthal coordinate towards zenithally-spaced areas, the panoramic collector being adapted to collect a corresponding return light beam onto the at least one focal area.

10. The ranging system of claim 1 wherein the panoramic projector includes a cylindrical body extending between a first end and a second end along the axis, the body being made of an optically transparent material, the first end having a convex shape, the second end having a conical recess, the convex shape and the conical recess being aligned with one another along the axis, the conical recess having a reflective surface, and the convex shape being adapted to collimate incoming light inside the cylindrical body and towards the second end, the reflective surface of the conical recess being adapted to reflect light towards azimuthally-spaced areas around the cylindrical body.

11. The ranging system of claim 1 wherein the at least one array of ToF sensors comprises one array of ToF sensors and the at least one focal area comprises one focal area, the focal area being positioned across the axis, the panoramic collector including four reflective lateral faces arranged in a rectangular pyramidal configuration, each of the four reflective lateral faces being adapted to receive a return light beam from a corresponding one of four azimuthal fields of view around the frame and to redirect the received return light beam towards the axis, and a focussing lens mounted to the housing and adapted to receive the reflected return light beam from the four reflective lateral faces and to focus the reflected return light beam towards the focal area across the axis, and wherein the array of ToF sensors is a rectangular array.

12. The ranging system of claim 1 wherein the panoramic projector comprises a plurality of optical sources mounted inside the housing, facing away from the axis and adapted to project the illumination beam comprising a plurality of illumination beams, and a plurality of projection lens assemblies mounted to the housing and adapted to project corresponding ones of the plurality of illumination beams towards different sets of azimuthally-spaced areas.

13. The ranging system of claim 1 wherein the at least one focal area includes a plurality of focal areas being parallel to and spaced from the axis, the at least one array of ToF sensors including a plurality of arrays of ToF sensors being positioned at corresponding ones of the plurality of focal areas, the panoramic collector comprising a plurality of collector lens assemblies mounted to the housing and adapted to collect corresponding return light beams on corresponding ones of the plurality of arrays of ToF sensors.

14. The ranging system of claim 13 wherein the plurality of arrays of ToF sensors are provided in the form of rectangular arrays of ToF sensors.

15. An integrated panoramic reflector comprising: a cylindrical body having a first end and a second end, the body extending along an axis between the first end and the second end, the body being made of an optically transparent material, the first end having a convex shape, the second end having a conical recess, the convex shape and the conical recess being aligned with one another along the axis, the conical recess having a reflective surface, and the convex shape being adapted to collimate incoming light inside the cylindrical body and towards the second end, the reflective surface of the conical recess being adapted to reflect light towards azimuthally-spaced areas around the cylindrical body.

16. The integrated panoramic reflector of claim 15 wherein the conical recess has an apex angle of 90 degrees.

17. The integrated panoramic reflector of claim 15 wherein the cylindrical body includes a first material and the conical recess includes a second material, the reflective surface being formed by selecting the first and second material such that the incoming light is reflected towards azimuthally-spaced areas via total internal reflection at an interface between the first material and the second material.

18. The integrated panoramic reflector of claim 15 wherein the cylindrical body is made by injection molding.

19. A panoramic collector comprising:
a frame;
an axis fixed relatively to the frame;
four reflective lateral faces arranged in a rectangular pyramidal configuration, each of the four reflective lateral faces being adapted to receive a return light beam from a corresponding one of four azimuthal fields of view around the frame and to redirect the received return light beam towards the axis; and
a lens assembly mounted to the frame and adapted to receive the reflected return light beam from the four reflective lateral faces and to focus the reflected return light beam towards a focal area across the axis.
